(19) United States
(12) Patent Application Publication
(10) Pub. No.: US 2012/0212880 A1
(43) Pub. Date: Aug. 23, 2012

(54) ELECTROLYTIC CAPACITOR AND METHOD OF MANUFACTURING ELECTROLYTIC CAPACITOR

(75) Inventors: Yoshiaki Ishimaru, Saga-shi (JP); Takayuki Matsumoto, Takeo-shi (JP)

(73) Assignees: SAGA SANYO INDUSTRIES CO., LTD., Saga (JP); SANYO ELECTRIC CO., LTD., Osaka (JP)

(21) Appl. No.: 13/402,545

(22) Filed: Feb. 22, 2012

(30) Foreign Application Priority Data
Feb. 22, 2011 (JP) 2011-035765

(51) Int. Cl. H01G 9/048; B05D 3/02; H01G 9/004

(52) U.S. Cl. 361/530; 427/80

(57) ABSTRACT

An electrolytic capacitor according to the present invention includes a wound element formed by winding an anode body consisting of a band-shaped metal foil and a dielectric coat provided on the surface of the metal foil and a cathode body consisting of a band-shaped metal foil in the longitudinal direction. The electrolytic capacitor includes a first conductive polymer layer provided on the surface of the anode body. The first conductive polymer layer is provided to be more thickly present on an end portion of the anode body in the width direction than on a central portion of the anode body in the width direction on the surface of the anode body.

This nonprovisional application is based on Japanese Patent Application No. 2011-035765 filed with the Japan Patent Office on Feb. 22, 2011, the entire contents of which are hereby incorporated by reference.

### BACKGROUND OF THE INVENTION

1. Field of the Invention

The present invention relates to an electrolytic capacitor and a method of manufacturing an electrolytic capacitor, and more particularly, it relates to a wound type electrolytic capacitor and a method of manufacturing an electrolytic capacitor.

2. Description of the Related Art

A CPU or the like has recently been required to have a higher speed of signal processing and higher voltage, in addition to the stream of downsizing of electronic apparatuses. Therefore, various attempts have been made for improving electric characteristics of an electrolytic capacitor by reducing equivalent series resistance (hereinafter abbreviated as “ESR”), reducing equivalent series inductance (hereinafter abbreviated as “ESL”) and improving withstand voltage characteristics.

For example, Japanese Patent Laying-Open No. 2007-184318 describes a technique of forming a conductive polymer layer containing a conducting agent in order to improve conductivity of the conductive polymer layer. This gazette describes that ESR of an electrolytic capacitor can be reduced by improving the conductivity of the conductive polymer layer, thereby improving electric characteristics of the electrolytic capacitor.

As an electrolytic capacitor including the aforementioned conductive polymer layer, there is a wound type electrolytic capacitor having a capacitor element formed by winding an anode body consisting of a band-shaped metal foil in the longitudinal direction. In view of mass production, the wound type electrolytic capacitor is currently prepared as follows:

First, chemical conversion is performed on a large-area metal foil, to form a dielectric coat on the surface of the metal foil. Then, the large-area metal foil is cut into the size of an anode body necessary for a capacitor element, for forming the anode body. At this time, no dielectric coat is formed on an end surface of the anode body newly exposed by the cutting, while deficient portions of the dielectric coat resulting from the cutting are present on a side surface in the vicinity of the end surface.

Then, a lead tab for electrically connecting the anode body with a lead wire is arranged on the surface of the prepared anode body, which in turn is wound in the longitudinal direction while winding the lead tab thereinto. Thus, a wound element is prepared. Then, chemical reconversion is performed on the prepared wound element for forming a dielectric coat on the end surface of the anode body or forming dielectric coats on the deficient portions of the dielectric coat on the side surface thereof, and a conductive polymer layer is thereafter formed by performing chemical oxidative polymerization or the like.

Through the aforementioned steps, a capacitor element employed for the wound type electrolytic capacitor is prepared. Then, the wound type electrolytic capacitor is prepared by storing the capacitor element in a case and sealing the same.

In the conventional method of manufacturing an electrolytic capacitor, however, it tends to be difficult to sufficiently restore deficient portions of the dielectric coat on the anode body, particularly the deficient portions of the dielectric coat present in a large number on the end surface of the anode body. The deficient portions remaining on the anode body of the electrolytic capacitor disadvantageously cause reduction of various characteristics such as reduction of electrostatic capacity, occurrence of a short circuit and formation of leakage current.

In order to solve the aforementioned problem, Japanese Patent Laying-Open No. 2007-53292, for example, describes a technique of prompting growth of a dielectric coat on a cut portion (end surface) of an anode body by dipping a wound element in a triethanol amine solution and thereafter performing chemical reconversion.

### SUMMARY OF THE INVENTION

In the technique described in Japanese Patent Laying-Open No. 2007-53292, however, a residue of the triethanol amine solution present in a capacitor element disadvantageously causes reduction of various characteristics such as reduction of electrostatic capacity and increase in ESR.

In consideration of the aforementioned circumstances, an object of the present invention is to provide an electrolytic capacitor having excellent electric characteristics and a method of manufacturing the same.

An electrolytic capacitor according to a first aspect of the present invention is an electrolytic capacitor including a wound element formed by winding an anode body consisting of a band-shaped metal foil and a dielectric coat provided on the surface of the metal foil and a cathode body consisting of a band-shaped metal foil in the longitudinal direction and including a first conductive polymer layer provided on the surface of the anode body, while the first conductive polymer layer is provided to be more thickly present on an end portion of the anode body in the width direction than on a central portion of the anode body in the width direction on the surface of the anode body.

A method of manufacturing an electrolytic capacitor according to a second aspect of the present invention is a method of manufacturing an electrolytic capacitor including a wound element formed by winding an anode body consisting of a band-shaped metal foil and a dielectric coat provided on the surface of the metal foil and a cathode body consisting of a band-shaped metal foil in the longitudinal direction, including the step of forming a first conductive polymer layer to be more thickly present on an end portion of the anode body in the width direction than on a central portion of the anode body in the width direction on the surface of the anode body, while the first conductive polymer layer containing a conductive solid is prepared from a liquid composition consisting of at least either a dispersion containing particles of the conductive solid or a solution in which the conductive solid is dissolved in the step of forming the first conductive polymer layer.

A method of manufacturing an electrolytic capacitor according to a third aspect of the present invention is a method of manufacturing an electrolytic capacitor including a wound element formed by winding an anode body consisting of a band-shaped metal foil and a dielectric coat provided on the surface of the metal foil and a cathode body consisting of a band-shaped metal foil in the longitudinal direction, including the steps of impregnating the wound element with a liquid composition consisting of at least either a dispersion containing particles of a conductive solid or a solution in which the conductive solid is dissolved and forming a first conductive polymer layer containing the conductive solid by heating the wound element impregnated with the liquid composition in a reduced pressure environment of not more than atmospheric pressure at a temperature of at least the boiling point of a solvent for the liquid composition.

A method of manufacturing an electrolytic capacitor according to a fourth aspect of the present invention is a method of manufacturing an electrolytic capacitor including a wound element formed by winding an anode body consisting of a band-shaped metal foil and a dielectric coat provided on the surface of the metal foil and a cathode body consisting of a band-shaped metal foil in the longitudinal direction, including the steps of applying a liquid composition consisting of at least either a dispersion containing particles of a conductive solid or a solution in which the conductive solid is dissolved to end portions of the anode body positioned on the sides of the upper surface and the bottom surface of the wound element respectively and forming a first conductive polymer layer containing the conductive solid by heating the wound element coated with the liquid composition.

A method of manufacturing an electrolytic capacitor according to a fifth aspect of the present invention is a method of manufacturing an electrolytic capacitor including a wound element formed by winding an anode body consisting of a band-shaped metal foil and a dielectric coat provided on the surface of the metal foil and a cathode body consisting of a band-shaped metal foil in the longitudinal direction, including the steps of applying a liquid composition consisting of at least either a dispersion containing particles of a conductive solid or a solution in which the conductive solid is dissolved to the surface of the anode body to be more thickly present on an end portion of the anode body in the width direction than on a central portion of the anode body in the width direction on the surface of the anode body, forming a first conductive polymer layer containing the conductive solid by heating the anode body coated with the liquid composition and forming the wound element by winding the anode body provided with the first conductive polymer layer in the longitudinal direction.

According to the present invention, an electrolytic capacitor having excellent electric characteristics and a method of manufacturing the same can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic sectional view of an electrolytic capacitor according to a first embodiment of the present invention;

FIG. 2 is a schematic perspective view showing the structure of a capacitor element in the electrolytic capacitor according to the first embodiment of the present invention;

FIG. 3 is a schematic sectional view partially showing the internal structure of the capacitor element in the electrolytic capacitor according to the first embodiment of the present invention;

FIG. 4 is a schematic sectional view showing the structure of a conductive polymer layer on an anode body in the electrolytic capacitor according to the first embodiment of the present invention;

FIG. 5 is a schematic sectional view showing the structure of a conductive polymer layer on an anode body in an electrolytic capacitor according to a modification of the first embodiment of the present invention;

FIG. 6 is a flow chart of a method of manufacturing an electrolytic capacitor according to a second embodiment of the present invention;

FIG. 7 is a schematic perspective view showing the structure of a wound element prepared in a step in the method of manufacturing an electrolytic capacitor according to the second embodiment of the present invention;

FIG. 8 is a flow chart of a method of manufacturing an electrolytic capacitor according to a third embodiment of the present invention;

FIG. 9 is a flow chart of a method of manufacturing an electrolytic capacitor according to a fourth embodiment of the present invention;

FIG. 10 is a schematic sectional view showing the structure of a conductive polymer layer on an anode body in an electrolytic capacitor according to a fifth embodiment of the present invention;

FIG. 11 is a schematic sectional view showing another structure of the conductive polymer layer on the anode body in the electrolytic capacitor according to the fifth embodiment of the present invention;

FIG. 12 is a flow chart of a method of manufacturing an electrolytic capacitor according to the fifth embodiment of the present invention;

FIG. 13 is an SEM photograph of a first conductive polymer layer formed according to Example 1; and

FIG. 14 is an SEM photograph of a first conductive polymer layer formed according comparative example 1.

### DESCRIPTION OF THE PREFERRED EMBODIMENTS

Embodiments of an electrolytic capacitor and a method of manufacturing an electrolytic capacitor according to the present invention are now described with reference to the drawings. The following embodiments are mere examples, and the present invention may be embodied in various ways within the range thereof. In the accompanying drawings, the same reference signs denote identical or corresponding portions.

### First Embodiment

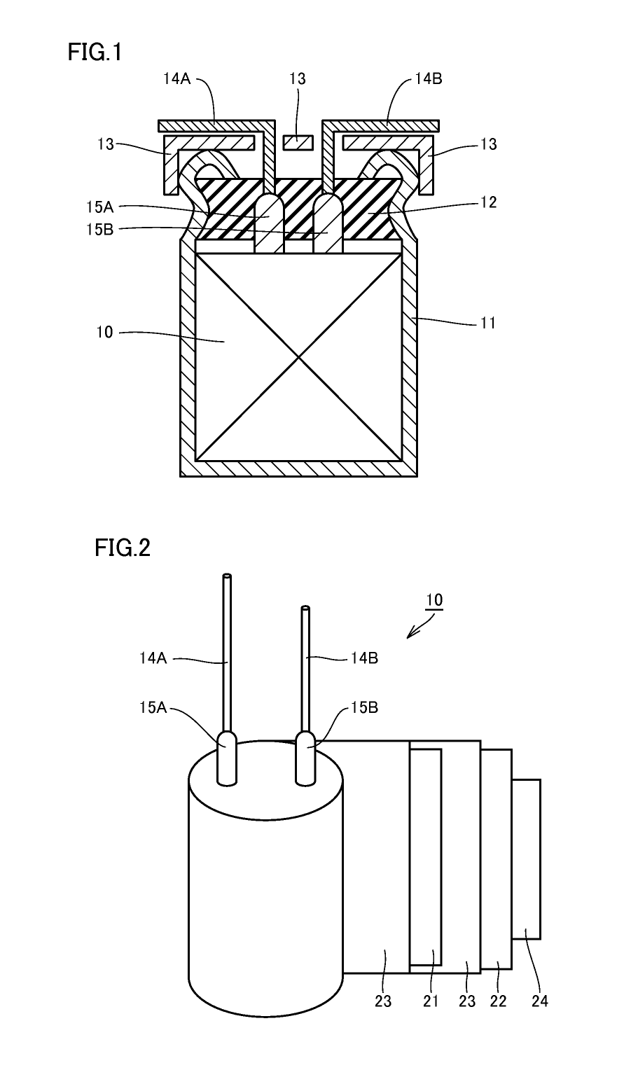

An electrolytic capacitor according to a first embodiment of the present invention is described with reference to FIGS. 1 to 4.

As shown in FIG. 1, the electrolytic capacitor according to the first embodiment includes a capacitor element 10, a bottomed case 11, a sealing member 12, a seat plate 13, lead wires 14A and 14B and lead tabs 15A and 15B.

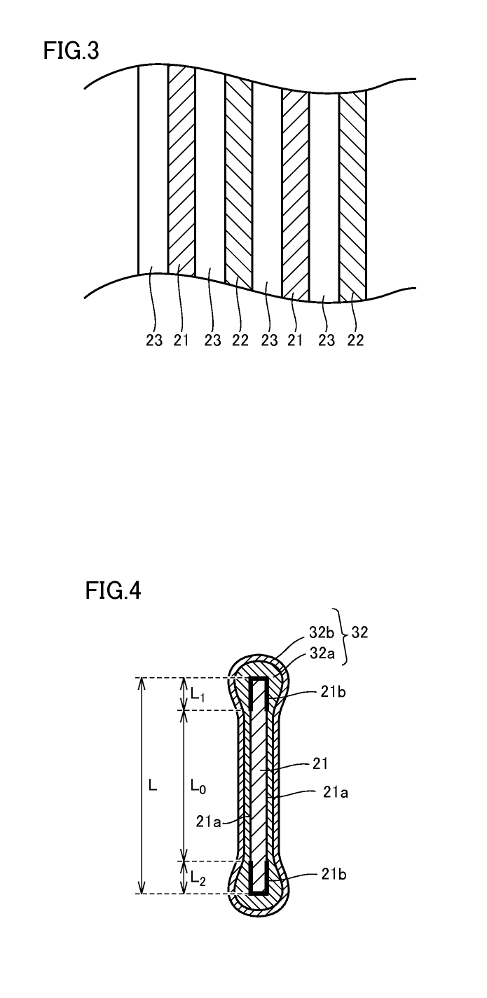

Capacitor element 10 is formed by winding a zonal anode body 21 and a zonal cathode body 22 in the longitudinal direction of anode body 21 through separators 23, as shown in FIG. 2. The outermost periphery of capacitor element 10 is fastened with a binding tape 24. In a cross section of capacitor element 10, turns of anode body 21 and cathode body 22 are alternately arranged in the radial direction of capacitor element 10 and separators 23 are provided between the turns of anode body 21 and cathode body 22, as shown in FIG. 3. Referring to FIG. 3, the vertical direction corresponds to the width direction of zonal anode body 21, and the direction from above the plane of the figure toward the rear side thereof corresponds to the longitudinal direction of anode body 21.

Referring again to FIG. 2, lead tab 15A is arranged between anode body 21 and separators 23, to be in contact with the surface of anode body 21. Lead tab 15B is arranged between cathode body 22 and separators 23, to be in contact with the surface of cathode body 22. In other words, lead tabs 15A and 15B are wound into capacitor element 10 in states connected to anode body 21 and cathode body 22 respectively. Lead wires 14A and 14B are connected to lead tabs 15A and 15B respectively. FIG. 2 shows capacitor element 10 in a state partially expanding the outermost periphery thereof.

Anode body 21 consists of a band-shaped metal foil and a dielectric coat provided on the surface of the metal foil. The surface of the band-shaped metal foil is roughened by etching or the like, so that anode body 21 has a large surface area. The metal foil is not particularly restricted, but may be made of a valve action metal such as aluminum, tantalum or niobium, for example. The dielectric coat is formed by chemically converting the surface of the metal foil, for example, and made of an oxide of the metal constituting the metal foil in this case. Alternatively, the dielectric coat may be stacked on the metal foil.

Cathode body 22 is not particularly restricted, but may simply be formed by a metal foil made of a valve action metal such as aluminum, tantalum or niobium, for example. The metals constituting anode body 21 and cathode body 22 may be identical to or different from each other.

Separators 23 are not particularly restricted, but may be nonwoven fabric mainly composed of synthetic cellulose, polyethylene terephthalate, vinylon, aramid fiber or the like, for example. Lead wires 14A and 14B and lead tabs 15A and 15B are not particularly restricted in material either, but may simply be prepared from well-known materials.

A conductive polymer layer (not shown) is present between anode body 21 and cathode body 22. The electrolytic capacitor functions as a capacitor, due to the presence of the conductive polymer layer. The electrolytic capacitor according to the first embodiment is characterized in the conductive polymer layer provided on anode body 21 in particular. The conductive polymer layer provided on anode body 21 is now described with reference to FIG. 4.

Referring to FIG. 4, the direction from above the plane of the figure toward the rear side thereof corresponds to the longitudinal direction of anode body 21, the vertical direction (direction L) corresponds to the width direction of anode body 21, and the horizontal direction corresponds to the thickness direction thereof. In the following description, a portion of anode body 21 located on a central portion (in the range L₀ in FIG. 4) in the width direction thereof is indicated as a central portion 21a, and portions located on end portions (in the ranges of L₁ and L₂ in FIG. 4) in the width direction thereof are indicated as end portions 21b and 21b respectively. In order to facilitate easy understanding, surface portions of anode body 21 corresponding to end portions 21b are shown with thick lines.

Referring to FIG. 4, a conductive polymer layer 32 including a first conductive polymer layer 32a and a second conductive polymer layer 32b is provided on the surface of anode body 21. First conductive polymer layer 32a is provided to be more thickly present on end portions 21b than on central portion 21a on the surface of anode body 21. In this case, the “thickness” denotes the distance from the surface of first conductive polymer layer 32a in contact with anode body 21 to the surface opposite thereto.

Second conductive polymer layer 32b is provided on first conductive polymer layer 32a. Second conductive polymer layer 32b may be provided on at least part of first conductive polymer layer 32a, or may be provided to cover the overall surface of first conductive polymer layer 32a as shown in FIG. 4. The overall surface of anode body 21 is covered with at least one of first conductive polymer layer 32a and second conductive polymer layer 32b.

According to the first embodiment, first conductive polymer layer 32a is provided to be thickly present on end portions 21b where a large number of deficient portions of the dielectric coat are present on the surface of anode body 21, whereby the deficient portions of the dielectric coat can be locally restored for the following reason:

When voltage is applied to the electrolytic capacitor including the dielectric coat having the deficient portions, current concentrates on the deficient portions. Thus, the temperatures of end portions 21b of anode body 21 having a large number of deficient portions rise. Portions of first conductive polymer layer 32a located on end portions 21b are thermally decomposed and converted to insulating layers due to the temperature rise on end portions 21b. However, the insulating layers can be formed with sufficient thicknesses, due to first conductive polymer layer 32a thickly present on end portions 21b. Thus, the insulating layers sufficiently cover the deficient portions, whereby reduction of electric characteristics such as reduction of electrostatic capacity resulting from the deficient portions, increase in ESR and increase in leakage current can be suppressed.

In particular, first conductive polymer layer 32a is preferably prepared from a liquid composition consisting of at least either a dispersion containing particles of a conductive solid or a solution in which the conductive solid is dissolved. The conductive solid denotes a conductive polymer dispersable in a solvent in a state of particles or a conductive polymer dissolvable in the solvent. More specifically, the liquid composition may be a liquid composition consisting of either a dispersion prepared by dispersing the conductive solid in a solvent or a solution prepared by dissolving the conductive solid in the solvent, or may be a liquid composition consisting of the aforementioned dispersion and the aforementioned solution. In the dispersion, the particles may be dispersed in the solvent in an aggregated state.

First conductive polymer layer 32a prepared from such a liquid composition is a layer formed by the particles of the conductive polymer intertwining with or bonding to each other on the surface of anode body 21. In other words, first conductive polymer layer 32a is a layer containing the conductive solid. The conductive solid tends to have a smaller molecular weight than a conductive polymer layer formed by chemical polymerization or electrolytic polymerization, and the weighted mean molecular weight thereof is at least 10³ and not more than 10⁶, for example.

First conductive polymer layer 32a containing the conductive solid has higher adhesion to anode body 21 as compared with a conductive polymer layer formed by chemical polymerization or electrolytic polymerization, for example. Therefore, adhesion between the insulating layers formed by thermal decomposition of first conductive polymer layer 32a and anode body 21 is also improved, whereby coverage for the deficient portions of the dielectric coat can be further improved.

The conductive solid can be prepared from a material obtained by supplying a dopant to a polymer such as polypyrrole, polythiophene, polyaniline or polyfuran or a derivative thereof, for example. The polymer is preferably prepared from polythiophene or a derivative thereof having excellent conductivity, and more preferably prepared from polyethylene dioxythiophene. The dopant can be prepared from polystyrene sulfonic acid, polysulfonic acid or polyvinyl sulfonic acid. In particular, polystyrene sulfonic acid is preferable in a point that the same can supply high conductivity to the aforementioned polymer. As a commercially available conductive solid, Baytron P (by Starck V Tech Ltd.), Denatron #LA (by Nagase & Co., Ltd.) or polyaniline (by Idemitsu Kosan Co., Ltd.) can be employed.

The solvent for dispersing and/or dissolving the conductive solid therein may simply be a solvent allowing dispersion or dissolution of the conductive solid. For example, the solvent can be prepared from water, methanol, ethanol, ethylene glycol, butanol, isopropanol, glycerin, ethylene glycol dimethyl ether, ethylene glycol monomethyl ether, ethylene glycol monobutyl ether, formamide, N-methyl acetoamide, N,N-dimethyl acetoamide, N-methylpyrolidone, N-methyl caprolactam or N-methyl formamide, which may be mixed with water.

Second conductive polymer layer 32b may be similar to first conductive polymer layer 32a, or may be a conductive polymer layer formed by chemical oxidative polymerization or electrolytic polymerization. The conductive polymer layer formed by chemical oxidative polymerization or electrolytic polymerization can be made of a material prepared by supplying a dopant to a basic skeleton of polypyrrole, polythiophene, polyaniline or polyfuran or a derivative thereof. The dopant may be prepared from a sulfonic acid compound such as alkyl sulfonic acid, aromatic sulfonic acid or polycycle aromatic sulfonic acid, or from nitric acid or sulfuric acid. In particular, p-toluenesulfonic acid is preferable in a point that the same can supply high conductivity.

Referring again to FIG. 1, capacitor element 10 is stored in bottomed case 11 to expose the upper surface from which lead tabs 15A and 15B are derived. Sealing member 12 formed to receive lead wires 14A and 14B therethrough is arranged on the upper surface of capacitor element 10 in bottomed case 11, and capacitor element 10 is sealed in bottomed case 11 due to this structure. A portion of bottomed case 11 in the vicinity of an opening end thereof is laterally drawn and curled, and seat plate 13 is arranged on the curled portion.

The material for bottomed case 11 is not particularly restricted, but may be a metal such as aluminum, stainless, copper, iron or brass, or an alloy thereof. The material for sealing member 12 is not particularly restricted either, so far as the same is insulative. Sealing member 12 may simply be made of an insulating elastic body, particularly insulating rubber such as silicone rubber, fluororubber, ethylene propylene rubber, high-pyrone rubber, butyl rubber or isoprene rubber having relatively high heat resistance and sealing performance.

In the electrolytic capacitor according to the first embodiment, conductive polymer layer 32 is provided on the surface of anode body 21, and first conductive polymer layer 32a is provided to be more thickly present on end portions 21b than on central portion 21a of the surface of anode body 21. According to this structure, deficient portions of the dielectric coat present in a large number on end portions 21b of anode body 21 can be covered with insulating layers formed by alteration of first conductive polymer layer 32a, as described above. Therefore, reduction of electric characteristics such as reduction of electrostatic capacity resulting from the deficient portions and increase in ESR can be suppressed. Consequently, the electrolytic capacitor according to the first embodiment is excellent in electric characteristics.

In general, an attempt has been made to restore deficient portions of a dielectric coat on the surface of an anode body by chemical reconversion. However, it is difficult to sufficiently restore deficient portions apt to concentrate on end surfaces of an anode body by a conventional technique, and deficient portions may remain in an electrolytic capacitor. According to the present invention, on the other hand, the deficient portions can be covered with insulating layers formed by alteration of first conductive polymer layer 32a caused by thermal decomposition, in place of or in addition to restoration of the dielectric coat by chemical reconversion.

In particular, the thickness of first conductive polymer layer 32a is so large on end potions 21b that the insulating layers (derived from first conductive polymer layer 32a) can sufficiently cover the deficient portions. Even if a portion of first conductive polymer layer 32a in the vicinity of anode body 21 alters into an insulating layer, first conductive polymer layer 32a can be left on the insulating layer while second conductive polymer layer 32b is present on first conductive polymer layer 32a, whereby the electrolytic capacitor can be prevented from reduction in function.

First conductive polymer layer 32a contains the conductive solid, whereby adhesion and bondability between first conductive polymer layer 32a and anode body 21 are improved. Thus, coverage for the deficient portions is further improved when first conductive polymer layer 32a contains the conductive solid.

The decomposition temperature of first conductive polymer layer 32a is preferably at least 200° C. and not more than 280° C. When the decomposition temperature of first conductive polymer layer 32a is not more than 280° C., more preferably not more than 250° C., the deficient portions can be restored before the temperatures thereof excessively rise, whereby the deficient portions can be inhibited from enlargement resulting from temperature rise. When the decomposition temperature of first conductive polymer layer 32a is at least 200° C., first conductive polymer layer 32a can be inhibited from excessive alteration. The decomposition temperature denotes a temperature at which the weight of the conductive solid constituting first conductive polymer layer 32a becomes not more than 95% of the weight at room temperature (about 25° C.).

Referring again to FIG. 4, the widths L₁ and L₂ of end portions 21b of anode body 21 are preferably at least 5% of the width (L) of anode body 21 respectively in the electrolytic capacitor according to the first embodiment. Thus, the deficient portions can be efficiently protected and restored. More preferably, the width L₁ or L₂ of either end portion 21b of anode body 21 is at least 20% of the width (L) of anode body 21.

While the electrolytic capacitor according to the first embodiment has been described with reference to FIGS. 1 to 4, the electrolytic capacitor according to the present invention is not restricted to the above. For example, first conductive polymer layers 32a included in a conductive polymer layer 32 may be provided on only end portions 21b of the surface of an anode body 21 while a second conductive polymer layer 32b may be provided on first conductive polymer layers 32a and on the surface of a central portion 21a of anode body 21 exposed from first conductive polymer layers 32a, as shown in FIG. 5. Also in this case, electric characteristics of an electrolytic capacitor can be improved, similarly to the first embodiment.

Also when first conductive polymer layers 32a are nonuniformly provided on a central portion 21a of the surface of an anode body 21 to be scattered on central portion 21a or to partially expose central portion 21a and more thickly provided on end portions 21b than on central portion 21a, electric characteristics of an electrolytic capacitor can be improved similarly to the above.

### Second Embodiment

A method of manufacturing an electrolytic capacitor according to the present invention is a method of manufacturing an electrolytic capacitor including a wound element formed by winding an anode body consisting of a band-shaped metal foil and a dielectric coat provided on the surface of the metal foil in the longitudinal direction, including the steps of forming a first conductive polymer layer to be more thickly present on end portions of the anode body in the width direction than on a central portion of the anode body in the width direction on the surface of the anode body and forming a second conductive polymer layer on the first conductive polymer layer, while the first conductive polymer layer containing a conductive solid is formed by employing a liquid composition consisting of at least either a dispersion containing particles of the conductive solid or a solution in which the conductive solid is dissolved in the step of forming the first conductive polymer layer. Thus, the aforementioned electrolytic capacitor according to the present invention can be manufactured.

A second embodiment of the present invention related to the aforementioned method of manufacturing an electrolytic capacitor is now described with reference to FIGS. 1, 2, 4, 6 and 7.

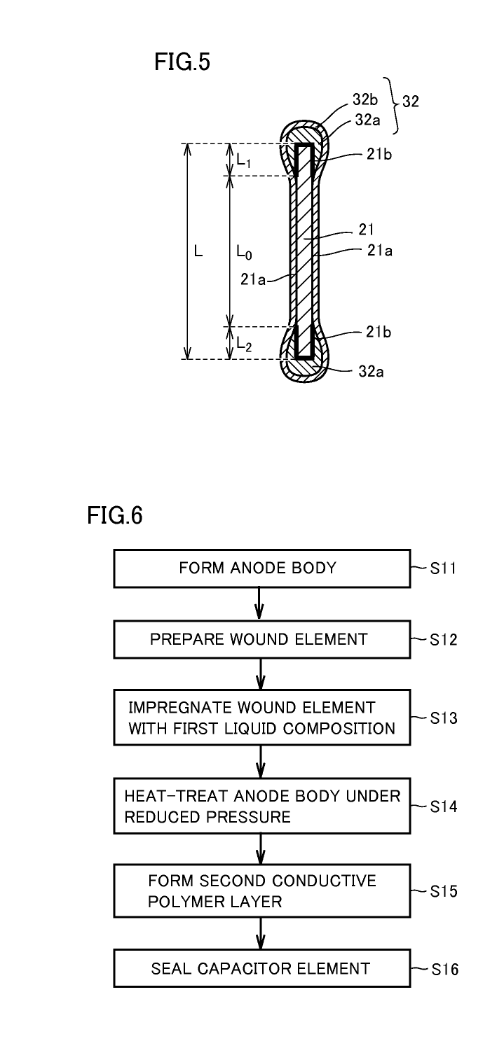

First, an anode body 21 is formed (step S11), as shown in FIG. 6. More specifically, the surface of a large-sized metal foil is first roughened. The metal constituting the metal foil, the type of which is not particularly restricted, may simply be prepared from a valve action metal such as aluminum, tantalum or niobium, in consideration of a point that a dielectric coat can be easily formed. Roughening denotes a technique of increasing the surface area of the metal foil by providing a plurality of recess portions on the surface of the metal foil. The plurality of recess portions may be formed on the surface of the metal foil by etching the metal foil, for example.

Then, a dielectric coat is formed on the roughened surface of the metal foil. While a method of forming the dielectric coat is not particularly restricted, the surface of the metal foil can be converted to a dielectric coat by chemically converting the metal foil when the metal foil is made of a valve action metal, for example. In order to perform chemical conversion, the metal foil may be dipped in a chemical conversion liquid such as an ammonium adipate solution or an aqueous phosphoric acid solution to be heat-treated, or voltage may be applied to the metal foil dipped in the aforementioned chemical conversion solution.

Then, the large-sized metal foil provided with the dielectric coat is cut into a prescribed size, to form anode body 21. Anode body 21 consisting of the metal foil having the dielectric coat provided thereon is formed through this step S11.

Then, a first conductive polymer layer 32a is formed to be more thickly present on end portions 21b of anode body 21 in the width direction than on a central portion 21a of anode body 21 in the width direction on the surface of anode body 21. More specifically, the following steps S12 to S14 are carried out:

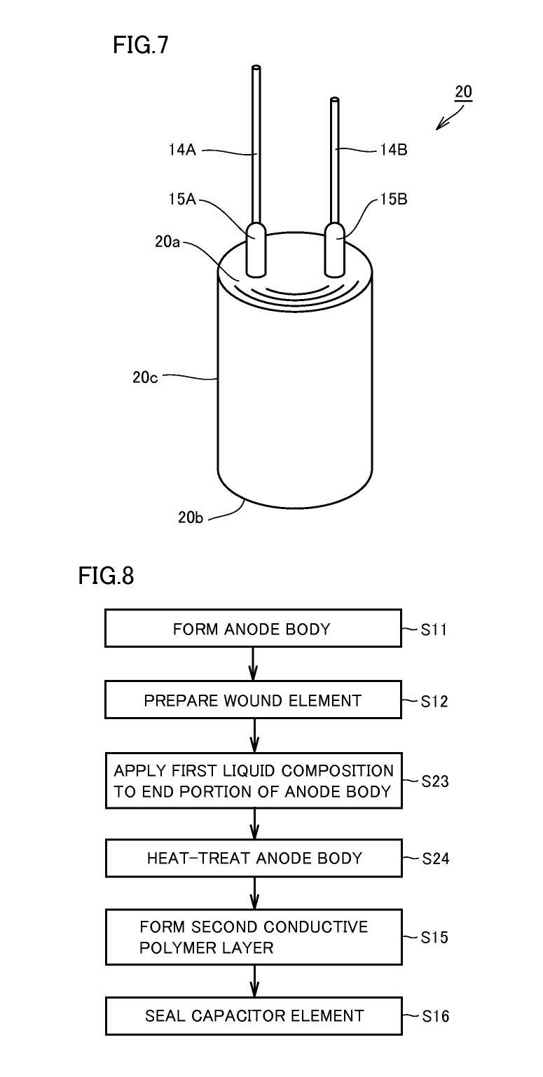

First, a wound element 20 is prepared, as shown in FIGS. 6 and 7 (step S12). Wound element 20 shown in FIG. 7 corresponds to a state of a capacitor element 10 not yet provided with a conductive polymer layer 32, and includes an upper surface 20a, a bottom surface 20b and a side surface 20c. End surfaces (edges) of wound anode body 21, a cathode body 22 and separators 23 are exposed on upper surface 20a and bottom surface 20b.

In order to prepare wound element 20, anode body 21 and cathode body 22 are first wound through separators 23. At this time, anode body 21 and cathode body 22 are wound while winding lead tabs 15A and 15B connected with lead wires 14A and 14B respectively between anode body 21 and separators 23 and between cathode body 22 and separators 23. Thus, lead tabs 15A and 15b can be uprightly provided in wound element 20, as shown in FIG. 7. Then, a binding tape 24 is arranged on the outer surface of cathode body 22 located on the outermost layer among wound anode body 21, cathode body 22 and separators 23, to fasten an end portion of cathode body 22 with binding tape 24. Thus, wound element 20 is prepared. Then, wound element 20 is dipped in a chemical conversion solution, for performing chemical reconversion of anode body 21. The chemical reconversion may not be performed.

Then, wound element 20 is impregnated with a first liquid composition, as shown in FIG. 6 (step S13). More specifically, prepared wound element 20 is dipped into the first liquid composition, to be impregnated with the first liquid composition. Thus, the first liquid composition adheres to the surface of anode body 21 in wound element 20.

The first liquid composition is a liquid composition consisting of at least either a dispersion containing particles of a conductive solid or a solution in which the conductive solid is dissolved, as described in relation to the first embodiment. The conductive solid may be a conductive polymer dispersable in a solvent in a state of particles or in a state of an aggregate or may be a conductive polymer dissolvable in the solvent, as described above. The conductive solid dispersable or dissolvable in the solvent can be prepared from a material obtained by supplying a dopant to a polymer such as polypyrrole, polythiophene, polyaniline or polyfuran or a derivative thereof, for example. As a commercially available conductive solid, Baytron P (by Starck V Tech Ltd.), Denatron #5002LA (by Nagase & Co., Ltd.) or polyaniline (by Idemitsu Kosan Co., Ltd.) can be employed, as described above.

The solvent for the first liquid composition may simply be a solvent allowing dispersion or dissolution of the conductive solid. For example, the solvent can be prepared from water, methanol, ethanol, ethylene glycol, butanol, isopropanol, glycerin, ethylene glycol dimethyl ether, ethylene glycol monomethyl ether, ethylene glycol monobutyl ether, formamide, N-methyl acetoamide, N,N-dimethyl acetoamide, N-methylpyrolidone, N-methyl caprolactam or N-methyl formamide, which may be mixed with water.

Preferably, the solvent for the first liquid composition can quickly move (flow) and is quickly evaporated and removed in heat treatment in a reduced pressure environment described later. Therefore, the solvent for the first liquid composition preferably has a low boiling point. The inventor has recognized that methanol, ethanol or isopropanol having a boiling point of not more than 100° C. can be suitably employed as the solvent for the first liquid composition in particular.

The content of the conductive solid in the first liquid composition is preferably at least 0.5 weight % and not more than 20 weight %. When the content of the conductive solid in the first liquid composition is at least 0.5 weight %, a sufficient quantity of conductive solid can be bonded onto end portions 21b in the step S14 described later. When the content of the conductive solid in the first liquid composition is not more than 20 weight %, the conductive solid can be homogeneously dispersed or dissolved in the solvent.

Then, wound element 20 impregnated with the first liquid composition is heat-treated in a reduced pressure environment of not more than atmospheric pressure at a temperature of at least the boiling point of the solvent for the first liquid composition, as shown in FIG. 6. Throughout this specification, atmospheric pressure denotes the standard atmospheric pressure, i.e., 101.3 kPa (with an error of less than ±5 kPa), and the reduced pressure environment denotes an environment having pressure reduced by at least 5 kPa from 101.3 kPa, i.e., pressure of not more than 96.3 kPa.

Wound element 20 impregnated with the first liquid composition is heated in the reduced pressure environment at the temperature of at least the boiling point of the solvent for the first liquid composition. Thus, the first liquid composition having been relatively homogeneously present in wound element 20 moves (flows) toward the sides of upper surface 20a and bottom surface 20b of wound element 20. As a result of this movement, the first liquid composition having homogeneously adhered to the overall surface of anode body 21 gathers on the surfaces of end portions 21b, and the solvent for the first liquid composition is evaporated and removed. Thus, first conductive polymer layers 32a containing the conductive solid can be more thickly formed on end portions 21b than on central portion 21a of the surface of anode body 21 (see FIG. 4). First conductive polymer layers 32a are formed through the aforementioned steps S12 to S14 in this manner.

Then, second conductive polymer layer 32b is formed on first conductive polymer layers 32a, as shown in FIG. 6 (step S15). Second conductive polymer layer 32b may be formed by employing a second liquid composition consisting of at least either a dispersion containing particles of a conductive solid or a solution in which the conductive solid is dissolved similarly to the first liquid composition, or may be formed by chemical polymerization or electrolytic polymerization.

In order to form second conductive polymer layer 32b by employing the second liquid composition, wound element 20 provided with first conductive polymer layers 32a is first dipped in the second liquid composition to be impregnated with the second liquid composition, for example. Thus, the second liquid composition adheres onto first conductive polymer layers 32a on anode body 21. Then, the solvent is removed from the second liquid composition by heating wound element 20, and second conductive polymer layer 32b containing the conductive solid is formed. The temperature for this heat treatment is not particularly restricted, but may be less than the boiling point of the solvent for the second liquid composition, for example. The environmental pressure is not restricted either, but may be atmospheric pressure, for example.

The composition of the second liquid composition may be identical to or different from that of the first liquid composition. In the case of forming second conductive polymer layer 32b by employing the second liquid composition, the solvent for the second liquid composition may not be quickly removed under reduced pressure at a high temperature dissimilarly to the step S13, and hence the boiling point of the solvent for the second liquid composition may not be low. However, the boiling point of the solvent for the second liquid composition is preferably low, so that the time required for the step of forming second conductive polymer layer 32b is shortened.

A method of forming second conductive polymer layer 32b by chemical polymerization is not particularly restricted. For example, wound element 20 may be dipped in a mixed solution prepared by mixing an oxidant, a precursor monomer for the polymer layer constituting second conductive polymer layer 32b and a dopant with each other, pulled up and allowed to stand for a prescribed time.

A method of forming second conductive polymer layer 32b by electrolytic polymerization is not particularly restricted either. For example, wound element 20 may be dipped in an electrolyte prepared by mixing the aforementioned precursor monomer and the dopant with each other, and current may be fed to first conductive polymer layers 32a.

The aforementioned precursor monomer may be a compound forming polypyrrole, polythiophene, polyaniline or polyfuran or a derivative thereof by polymerization. The aforementioned precursor monomer can be prepared from 3,4-ethylene dioxythiophene, 3-alkylthiophene, N-methylpyrrole, N,N-dimethylaniline or N-alkylaniline, for example. When 3,4-ethylene dioxythiophene which is one of precursor monomers of polythiophene is employed as the aforementioned precursor monomer, second conductive polymer layer 32b having high conductivity can be formed. Therefore, the aforementioned precursor monomer is more preferably prepared from 3,4-ethylene dioxythiophene.

Conductive polymer layer 32 having second conductive polymer layer 32b provided on first conductive polymer layers 32a is formed on anode body 21 through this step S15, and capacitor element 10 having conductive polymer layer 32 provided on anode body 21 is prepared through the aforementioned steps S11 to S15 (see FIG. 2).

Then, capacitor element 10 is sealed, as shown in FIG. 6 (step S16). More specifically, capacitor element 10 is first stored in a bottomed case 11, so that lead wires 14A and 15B are positioned on an opening end of bottomed case 11. Then, a sealing member 12 formed to receive lead wires 14A and 14B therethrough is arranged above capacitor element 10, to seal capacitor element 10 in bottomed case 11. Then, a portion of bottomed case 11 sealing capacitor element 10 in the vicinity of the opening end thereof is laterally drawn and curled. Then, a seat plate 13 is arranged on the curled portion, thereby manufacturing the electrolytic capacitor shown in FIG. 1.

According to the method of manufacturing an electrolytic capacitor according to the second embodiment, first conductive polymer layers 32a can be easily formed on end portions 21b of anode body 21 more thickly than on central portion 21a with a high yield. Therefore, end portions 21b where a large number of deficient portions of a dielectric coat are present can be sufficiently covered with insulating layers formed by alteration of first conductive polymer layers 32a unevenly distributed on end portions 21b. According to the method of manufacturing an electrolytic capacitor according to the second embodiment, therefore, an electrolytic capacitor having excellent electric characteristics can be manufactured while suppressing reduction of electric characteristics such as reduction of electrostatic capacity resulting from the deficient portions, increase in ESR and increase in leakage current.

Referring to FIG. 4, the steps S13 and S14 are preferably so carried out that widths L₁ and L₂ of portions provided with first conductive polymer layers 32a, i.e., end portions 21b of anode body 21 are at least 5% of the width (L) of anode body 21 respectively. The aforementioned deficient portions of the dielectric coat can be efficiently protected or restored by ensuring the widths of first conductive polymer layers 32a by at least 5% in the width direction of anode body 21. More preferably, the steps S13 and S14 are so carried out that the width L₁ or L₂ of either end portion 21b of anode body 21 is at least 20% of the width (L) of anode body 21.

According to the method of manufacturing an electrolytic capacitor according to the second embodiment, the deficient portions of the dielectric coat are restored by unevenly distributing first conductive polymer layers 32a, whereby an electrolytic capacitor having excellent electric characteristics can be manufactured through simple steps.

### Third Embodiment

A method of manufacturing an electrolytic capacitor according to a third embodiment of the present invention is now described with reference to FIGS. 5 and 8. In the third embodiment, steps S11, S12, S15 and S16 of forming an anode body 21, preparing a wound element 20, forming a second conductive polymer layer 32b and sealing a capacitor element are similar to those in the second embodiment, and hence redundant description is not repeated. Steps S23 and S24 are now described.

As shown in FIG. 8, a first liquid composition is applied to end portions 21b of anode body 21 (step S23) after preparing wound element 20 through the step S12. More specifically, the first liquid composition is applied to end portions 21b of anode body 21 positioned on the sides of an upper surface 20a and a bottom surface 20b of wound element 20 respectively. A method of applying the first liquid composition is not particularly restricted, but the first liquid composition may be sprayed toward the sides of upper surface 20a and bottom surface 20b, or may be smeared on end portions 21b of anode body 21 with a brush or the like, for example. Thus, the first liquid composition adheres to end portions 21b of anode body 21 wound in wound element 20.

Then, wound element 20 having the first liquid composition adhering to end portions 21b of anode body 21 is heat-treated at the step S24, as shown in FIG. 8. Thus, a solvent is removed from the first liquid composition, and first conductive polymer layers 32a containing a conductive solid are formed (see FIG. 5). The temperature for this heat treatment is not particularly restricted, but may be less than the boiling point of the solvent. The environmental pressure is not particularly restricted either, but may be atmospheric pressure.

First conductive polymer layers 32a containing the conductive solid can be formed more thickly on end portions 21b than on a central portion 21a of the surface of anode body 21 through the aforementioned steps S23 and S24.

According to the method of manufacturing an electrolytic capacitor according to the third embodiment, first conductive polymer layers 32a can be easily more thickly formed on end portions 21b than on central portion 21a of anode body 21 with a high yield. Therefore, deficient portions of a dielectric coat can be sufficiently covered with insulating layers formed by alteration of first conductive polymer layers 32a unevenly distributed on end portions 21b. According to the method of manufacturing an electrolytic capacitor according to the third embodiment, therefore, an electrolytic capacitor having excellent electric characteristics can be manufactured while suppressing reduction of electric characteristics such as reduction of electrostatic capacity resulting from the deficient portions, increase in ESR and increase in leakage current.

The remaining steps of the third embodiment are similar to those of the second embodiment, and hence redundant description is not repeated.

### Fourth Embodiment

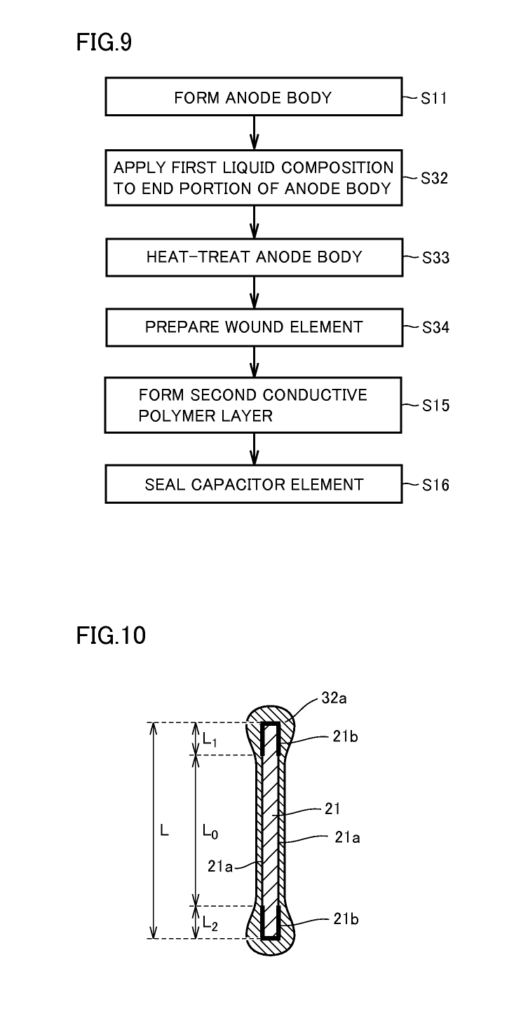

A method of manufacturing an electrolytic capacitor according to a fourth embodiment of the present invention is specifically described with reference to FIGS. 5 and 9. In the fourth embodiment, steps S11, S15 and S16 of forming an anode body 21, forming a second conductive polymer layer 32b and sealing a capacitor element are similar to those in the second embodiment, and hence redundant description is not repeated. Steps S32 to S34 are now described.

As shown in FIG. 9, a first liquid composition is applied to end portions 21b of anode body 21 in the step S32 after forming anode body 21 through the step S11. More specifically, the first liquid composition is applied to anode body 21 to be more thickly present on end portions 21b than on a central portion 21a on the surface of anode body 21 not yet wound. The first liquid composition may not be applied to central portion 21a. Anode body 21 employed in the step 32 has been subjected to chemical reconversion and provided with a lead tab 15A on the surface thereof after chemical conversion and cutting and before application of the first liquid composition. Alternatively, the chemical reconversion may not be performed.

Then, anode body 21 having the first liquid composition adhering thereto is heat-treated at the step S33, as shown in FIG. 9. Thus, a solvent is removed from the first liquid composition, and first conductive polymer layers 32a containing a conductive solid are formed (see FIG. 5). The temperature for this heat treatment is not particularly restricted, but may be less than the boiling point of the solvent. The environmental pressure is not restricted either, but may be about atmospheric pressure. Through the aforementioned steps S32 and S33, first conductive polymer layers 32a can be more thickly formed on end portions 21b than on a central portion 21a of the surface of anode body 21.

Then, a wound element 20 shown in FIG. 7 is prepared by employing anode body 21 provided with first conductive polymer layers 32a in the step S34, as shown in FIG. 9. A method of preparing wound element 20 is similar to that in the step S12 of the second embodiment. As to wound element 20 prepared in the fourth embodiment, however, the step S34 is different from the step S12 of the second embodiment in a point that first conductive polymer layers 32a have already been formed on the surface of anode body 21.

Through the aforementioned steps S32 to S34, first conductive polymer layers 32a containing the conductive solid can be more thickly formed on end portions 21b than on central portion 21a of the surface of anode body 21.

According to the method of manufacturing an electrolytic capacitor according to the fourth embodiment, first conductive polymer layers 32a can be easily more thickly formed on end portions 21b than on central portion 21a of anode body 21 with a high yield. Therefore, deficient portions of a dielectric coat on end portions 21b can be sufficiently covered with insulating layers formed by alteration of first conductive polymer layers 32a unevenly distributed on end portions 21b. According to the method of manufacturing an electrolytic capacitor according to the fourth embodiment, therefore, an electrolytic capacitor having excellent electric characteristics can be manufactured while suppressing reduction of electric characteristics such as reduction of electrostatic capacity resulting from the deficient portions, increase in ESR and increase in leakage current.

The remaining steps of the fourth embodiment are similar to those of the second embodiment, and hence redundant description is not repeated.

### Fifth Embodiment

An electrolytic capacitor according to a fifth embodiment of the present invention is described with reference to FIG. 10. In the electrolytic capacitor according to the fifth embodiment, a space between an anode body 21 and a cathode body 22 is filled with an electrolyte, in place of a second conductive polymer layer provided on anode body 21. The point of the fifth embodiment different from the aforementioned first embodiment is now mainly described.

As the electrolyte, a solution utilizable as an electrolyte for a capacitor can be employed without particular restriction. More specifically, a solvent utilizable as that for an electrolyte for a capacitor can be employed without particular restriction. For example, the solvent can be prepared from y-butylolactone, ethylene glycol, sulfolane or propylene carbonate, which may be mixed with each other.

As a supporting electrolyte, a supporting electrolyte utilizable as that for an electrolyte for a capacitor can be employed without particular restriction. For example, the supporting electrolyte can be prepared from phthalic amidine salt, tetramethylammonium phthalate, ammonium adipate or trimethylamine phthalate, which may be mixed with each other. The aforementioned electrolyte may contain substantially no supporting electrolyte.

The concentration of the supporting electrolyte in the electrolyte, which cannot be generalized since the same depends on the materials for the solvent and the supporting electrolyte, is preferably not more than 5 mol/L, for example.

The aforementioned electrolyte may further contain an additive, in addition to the supporting electrolyte and the solvent. As the additive, an additive utilizable as that for an electrolyte for a capacitor can be employed without particular restriction. For example, the additive can be prepared from a phosphoric acid-based compound such as phosphoric ester, a boric acid-based compound such as boric acid, a nitro compound such as p-nitrophenol or polysaccharide such as mannitol, or at least two such materials may be employed. The aforementioned electrolyte may contain substantially no additive.

In the electrolytic capacitor according to the fifth embodiment, deficient portions of a dielectric coat present in a large number on end portions 21b of anode body 21 can be covered not only with insulating layers derived from a first conductive polymer layer 32a but also with the electrolyte. Thus, the deficient portions of the dielectric coat are restored also by the electrolyte in the electrolytic capacitor according to the fifth embodiment, whereby reduction of electrostatic capacity, increase in ESR and generation of leakage current can be more suppressed as compared with the electrolytic capacitor according to the aforementioned first embodiment.

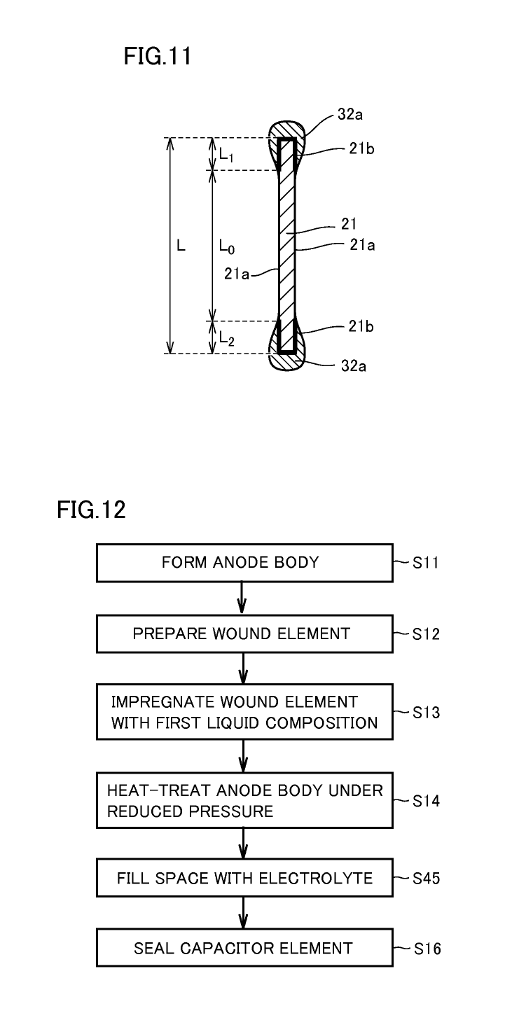

The electrolytic capacitor according to the fifth embodiment is not restricted to the structure shown in FIG. 10. For example, first conductive polymer layers 32a may be provided only on end portions 21b of the surface of an anode body 21 so that a space between anode body 21 and a cathode body 22 is filled with an electrolyte, as shown in FIG. 11. Further, a space between anode body 21 and cathode body 22 may be filled with an electrolyte in the electrolytic capacitor according to the aforementioned first embodiment. In either case, effects similar to those of the electrolytic capacitor according to the fifth embodiment can be attained.

A method of manufacturing an electrolytic capacitor according to the fifth embodiment of the present invention is described with reference to FIG. 12. In the fifth embodiment, steps S11, S12, S13, S14 and S16 of forming anode body 21, preparing a wound element 20, impregnating wound element 20 with a first liquid composition, heat-treating anode body 21 under reduced pressure and sealing a capacitor element are similar to those in the second embodiment, and hence redundant description is not repeated. A step S45 is now described.

As shown in FIG. 12, the space between anode body 21 provided with first conductive polymer layer 32a and cathode body 22 is filled with an electrolyte (step S45), after anode body 21 is heat-treated under reduced pressure at the step S14. More specifically, wound element 20 provided with first conductive polymer layer 32a is first dipped in the electrolyte. At this time, environmental pressure is not particularly restricted, but may be atmospheric pressure, for example. The electrolyte is as described above.

According to the method of manufacturing an electrolytic capacitor according to the fifth embodiment, the space between anode body 21 and cathode body 22 is filled with the electrolyte, whereby the deficient portions of the dielectric coat present in a large number on end portions 21b of anode body 21 can be covered also with the electrolyte. Thus, reduction of electric characteristics such as reduction of electrostatic capacity resulting from the deficient portions, increase in ESR and increase in leakage current are further suppressed, whereby an electrolytic capacitor having more excellent electric characteristics can be manufactured.

The method of manufacturing an electrolytic capacitor according to the fifth embodiment is not restricted to that shown in FIG. 12. For example, the step (step S45) of filling the space with the electrolyte according to the fifth embodiment may be carried out in place of the step (step S15) of forming the second conductive polymer layer in the aforementioned third or fourth embodiment. Further, the step (step S45) of filling the space with the electrolyte according to the fifth embodiment may be carried out after the step (step S15) of forming the second conductive polymer layer and before the step (step S16) of sealing the capacitor element in the aforementioned second, third or fourth embodiment.

The step (step S45) of filling the space with the electrolyte according to the fifth embodiment is not restricted to the above description. For example, the electrolyte may be injected into a bottomed case 11 after storing a capacitor element 10 provided with first conductive polymer layer 32a so that lead wires 14A and 14B are positioned on an opening end of bottomed case 11. In this case, a portion of bottomed case 11 in the vicinity of the opening end thereof may be laterally drawn and curled, so that a seat plate 13 is thereafter arranged on the curled portion.

### EXAMPLES

While the present invention is now described in more detail with reference to Examples, the present invention is not restricted to these.

### Example 1

In Example 1, a wound type electrolytic capacitor was prepared by the method of manufacturing an electrolytic capacitor according to the second embodiment. The method of manufacturing the wound type electrolytic capacitor according to Example 1 is now more specifically described.

First, the surface of an aluminum foil was roughened by etching, and a dielectric coat was thereafter formed on the surface of the aluminum foil by chemical conversion. The chemical conversion was performed by dipping the aluminum foil in an ammonium adipate solution and applying voltage thereto. The aluminum foil was cut into an anode body of 3 mm by 120 mm.

Then, separators and a cathode body each having an area similar to that of the aforementioned anode body were prepared. An anode lead tab and a cathode lead tab were arranged on the surfaces of the anode body and the cathode body respectively, then the anode body, the cathode body and the separators were wound while winding the anode lead tab and the cathode lead tab thereinto, and a binding tape was stuck to the outer surface of the wound body, thereby preparing a wound element. The cathode body was formed by an aluminum foil. The prepared wound element was subjected to chemical reconversion.

Then, the wound element was dipped in a first liquid composition containing a conductive solid and a solvent for one minute, to be impregnated with the first liquid composition. The conductive solid was prepared by doping polyethylene dioxythiophene with polystyrene sulfonic acid, and the solvent was prepared from ethanol (boiling point: 78.4° C.). The concentration of the conductive solid in the solvent was 3 mass %. The decomposition temperature of polyethylene dioxythiophene is 240° C.

Then, the wound element pulled up from the first liquid composition was heat-treated in an environment of −80 kPa at 150° C. for 20 minutes, thereby forming a first conductive polymer layer.

Then, a second liquid composition having a composition similar to that of the first liquid composition was prepared, and the wound element provided with the first conductive polymer layer was dipped in the second liquid composition for one minute, to be impregnated with the second liquid composition. Then, the wound element pulled up from the second liquid composition was heat-treated in an atmospheric pressure environment at 75° C. for 20 minutes, thereby forming a second conductive polymer layer. A capacitor element was prepared through the aforementioned steps.

Then, the prepared capacitor element was stored in a bottomed case so that lead wires were positioned on an opening end of the bottomed case, and a rubber packing serving as a sealing member formed to receive the lead wires therethrough was arranged above the capacitor element, to seal the capacitor element in the bottomed case. A portion of the bottomed case in the vicinity of the opening end thereof was laterally drawn and thereafter curled, and a seat plate was arranged on the curled portion, thereby manufacturing the wound type electrolytic capacitor.

### Example 2

An electrolytic capacitor was manufactured by a method similar to that of Example 1, except that a wound element was heat-treated in an environment of −80 kPa at 100° C. for 20 minutes in a step of forming a first conductive polymer layer.

### Example 3

An electrolytic capacitor was manufactured by a method similar to that of Example 1, except that a solvent for a first liquid composition was prepared from water (boiling point: 100° C.) in a step of forming a first conductive polymer layer.

### Example 4

An electrolytic capacitor was manufactured by a method similar to that of Example 1, except that a solvent for a first liquid composition was prepared from butanol (boiling point: 117° C.) in a step of forming a first conductive polymer layer.

### Example 5

An electrolytic capacitor was manufactured by a method similar to that of Example 1, except that polyaniline doped with di-iso-octyl sodium sulfosuccinate was employed as a conductive solid in a step of forming a first conductive polymer layer. The decomposition temperature of polyaniline is 275° C.

### Example 6

An electrolytic capacitor was manufactured by a method similar to that of Example 1, except that a second conductive polymer layer was formed by chemical polymerization in a step of forming the second conductive polymer layer. The second conductive polymer layer was formed as follows:

The second conductive polymer layer was formed by dipping a wound element in a mixed solution containing 3,4-ethylene dioxythiophene and ferric p-toluenesulfonate by 3 mol/L and 1 mol/L respectively for 10 seconds, thereafter pulling up the wound element from the mixed solution and allowing the same to stand at room temperature for three hours. The wound element provided with the second conductive polymer layer was heated to 180° C., to remove a residual solvent.

### Example 7

In Example 7, a wound type electrolytic capacitor was prepared by employing the method of manufacturing an electrolytic capacitor according to the third embodiment. The method of manufacturing this electrolytic capacitor is now more specifically described.

First, a wound element was prepared by a method similar to that in Example 1, and the prepared wound element was subjected to chemical reconversion. Then, a first liquid composition was applied to end portions of an anode body positioned on the sides of the upper surface and the bottom surface of the prepared wound element respectively by spraying. The composition of the first liquid composition was similar to that of the first liquid composition employed in Example 1. The first liquid composition was applied by 0.05 ml to each of the end portions on the sides of the upper surface and the bottom surface of the wound element. Then, the wound element coated with the first liquid composition was heat-treated in an atmospheric pressure environment at 75° C. for 20 minutes, thereby forming a first conductive polymer layer. Then, the wound type electrolytic capacitor was manufactured by forming a second conductive polymer layer by a method similar to that in Example 1 and sealing a prepared capacitor element.

### Example 8

In Example 8, a wound type electrolytic capacitor was prepared by employing the method of manufacturing an electrolytic capacitor according to the fourth embodiment. The method of manufacturing this electrolytic capacitor is now specifically described.

First, an anode body was formed by a method similar to that in Example 1, and the anode body was subjected to chemical reconversion by a method similar to chemical conversion. Then, lead tabs were arranged on the surface of the anode body, and a first liquid composition was applied to end portions of the surface of the anode body. The composition of the first liquid composition was similar to that of the first liquid composition in Example 1. The first liquid composition was applied to a region of 5% with respect to 100% of the width of the anode body on each of the end portions. In other words, the first liquid composition was applied by 0.05 ml on each region of a width of 0.15 mm from each end of the anode body having a width of 3 mm. Then, first conductive polymer layers were formed by heat-treating the anode body in an atmospheric pressure environment at 750° C. for 20 minutes. Then, this anode body was employed for manufacturing the wound type electrolytic capacitor by preparing a wound element, forming a second conductive polymer layer and sealing a capacitor element, similarly to the method employed in Example 1. According to Example 8, the prepared wound element was not subjected to chemical conversion.

### Example 9

An electrolytic capacitor was manufactured by a method similar to that of Example 1, except that a wound element provided with a first conductive polymer layer was impregnated with an electrolyte in place of formation of a second conductive polymer layer. The electrolyte contained a solvent of y-butylolactone and a supporting electrolyte of tetramethylammonium phthalate, and was so prepared that the concentration of the supporting electrolyte was 0.5 mol/L.

### Example 10

An electrolytic capacitor was manufactured by a method similar to that of Example 1, except that a capacitor element was impregnated with an electrolyte after a second conductive polymer layer was formed and before the capacitor element was sealed. The electrolyte was similar to that used in Example 9.

### Comparative Example 1

An electrolytic capacitor was manufactured by a method similar to that in Example 1, except that a wound element was heat-treated in an atmospheric pressure environment at 75° C. for 20 minutes in a step of forming a first conductive polymer layer.

### Comparative Example 2

An electrolytic capacitor was manufactured by a method similar to that in Example 1, except that a wound element was heat-treated in an environment of −80 kPa at 75° C. for 20 minutes in a step of forming a first conductive polymer layer.

### Comparative Example 3

An electrolytic capacitor was manufactured by a method similar to that in Example 1, except that a wound element was heat-treated in an atmospheric pressure environment at 75° C. for 10 minutes and thereafter continuously heat-treated at 150° C. for 10 minutes in a step of forming a first conductive polymer layer.

### Comparative Example 4

An electrolytic capacitor was manufactured by a method similar to that of comparative example 1, except that a wound element provided with a first conductive polymer was impregnated with an electrolyte in place of formation of a second conductive polymer layer. The electrolyte was similar to that used in Example 9.

Table 1 shows conditions for manufacturing the electrolytic capacitors according to Examples 1 to 10 and comparative examples 1 to 4. The electrolytic capacitor according to each of Examples 1 to 10 and comparative examples 1 to 4 had a diameter of 10 mm and a height of 8 mm, while rated voltage and rated capacity were 35 RV and 18 μF respectively.

TABLE 1

| | Conditions for Forming First | | |
|---|---|---|---|
| | Conductive Polymer Layer | | |
| | Solvent | | |
| | for First | | Method of Forming |
| | Liquid | Heat Treatment | Second Conductive |
| | Component | Conditions | Polymer Layer |
| Example 1 | ethanol | −80 kPa, 150° C., 20 | dispersion |
| | | minutes | |
| Example 2 | ethanol | −80 kPa, 100° C., 20 | dispersion |
| | | minutes | |
| Example 3 | water | −80 kPa, 150° C., 20 | dispersion |
| | | minutes | |
| Example 4 | butanol | −80 kPa, 150° C., 20 | dispersion |
| | | minutes | |
| Example 5 | ethanol | −80 kPa, 150° C., 20 | dispersion |
| | | minutes | |
| Example 6 | ethanol | −80 kPa, 150° C., 20 | chemical |
| | | minutes | polymerization |
| Example 7 | ethanol | atmospheric pressure, | dispersion |
| | | 75° C., 20 minutes | |
| Example 8 | ethanol | atmospheric pressure, | dispersion |
| | | 75° C., 20 minutes | |
| Example 9 | ethanol | −80 kPa, 150° C., 20 | not formed (filled |
| | | minutes | with electrolyte) |
| Example 10 | ethanol | −80 kPa, 150° C., 20 | dispersion |
| | | minutes | |
| Comparative | ethanol | atmospheric pressure, | dispersion |
| Example 1 | | 75° C., 20 minutes | |
| Comparative | ethanol | −80 kPa, 75° C., 20 | dispersion |
| Example 2 | | minutes | |
| Comparative | ethanol | atmospheric pressure, | dispersion |
| Example 3 | | 75° C., 10 minutes | |
| | | atmospheric pressure, | |
| | | 150° C., 10 minutes | |
| Comparative | ethanol | atmospheric pressure, | not formed (filled |
| Example 4 | | 75° C., 20 minutes | with electrolyte) |

(Electrostatic Capacity)

20 samples were randomly selected out of 100 electrolytic capacitors according to each of Examples 1 to 10 and comparative examples 1 to 4. Initial electrostatic capacity values (μF) of the selected 20 electrolytic capacitors according to each of Examples 1 to 10 and comparative examples 1 to 4 at a frequency of 120 Hz were measured with an LCR meter for four-terminal measurement. Table 2 shows average values of the results.

(ESR)

As to the selected 20 electrolytic capacitors according to each of Examples 1 to 10 and comparative examples 1 to 4, ESR values (mΩ) at a frequency of 100 kHz were measured with the LCR meter for four-terminal measurement. Table 2 shows average values of the results.

(Leakage Current)

20 samples were randomly selected out of 100 electrolytic capacitors according to each of Examples 1 to 10 and comparative examples 1 to 4, and rated voltage was applied to the selected electrolytic capacitors for two minutes. After the voltage application, quantities (μA) of leakage current in the electrolytic capacitors were measured. Table 2 shows average values of the results.

(Withstand Voltage)

20 samples were randomly selected out of 100 electrolytic capacitors according to each of Examples 1 to 10 and comparative examples 1 to 4. Direct voltage applied to the selected electrolytic capacitors was increased at a speed of 1 V/sec., to conduct a withstand voltage test. Voltage at which eddy current exceeded 0.5 A was regarded as withstand voltage (V). Table 2 shows average values of the results.

TABLE 2

| | Electrostatic | | Leakage | Withstand |
|---|---|---|---|---|
| | Capacity | ESR | Current | Voltage |
| | (μF) | (mΩ) | (μA) | (V) |
| Example 1 | 18.6 | 26.5 | 0.2 | 142.2 |
| Example 2 | 18.1 | 25.8 | 0.1 | 134.5 |
| Example 3 | 18.2 | 27 | 0.4 | 136.3 |
| Example 4 | 18.1 | 28 | 0.8 | 132.2 |
| Example 5 | 18.1 | 27.5 | 0.9 | 133.4 |
| Example 6 | 18.1 | 25.5 | 1.8 | 138.2 |
| Example 7 | 18 | 28 | 2.3 | 134 |
| Example 8 | 18 | 29.8 | 9 | 125.3 |
| Example 9 | 19.8 | 26.9 | 0.2 | 140.5 |
| Example 10 | 19.5 | 24.5 | 0.1 | 143.3 |
| Comparative | 18.3 | 26.8 | 12.4 | 85.5 |
| Example 1 | | | | |
| Comparative | 18.2 | 29.1 | 11.1 | 90.4 |
| Example 2 | | | | |
| Comparative | 17.9 | 28.8 | 33.2 | 89.2 |
| Example 3 | | | | |
| Comparative | 18.8 | 24.9 | 1.5 | 97.7 |
| Example 4 | | | | |

Referring to Tables 1 and 2, it has been recognized that Examples 1 to 10 were particularly excellent in leakage current characteristics and withstand voltage characteristics by comparing Examples 1 to 10 and comparative examples 1 to 4 with each other. In the electrolytic capacitors according to Example 1 and comparative example 1, the wound elements provided with the first conductive polymer layers were decomposed to confirm the positions provided with the first conductive polymer layers with a scanning electron microscope (SEM).

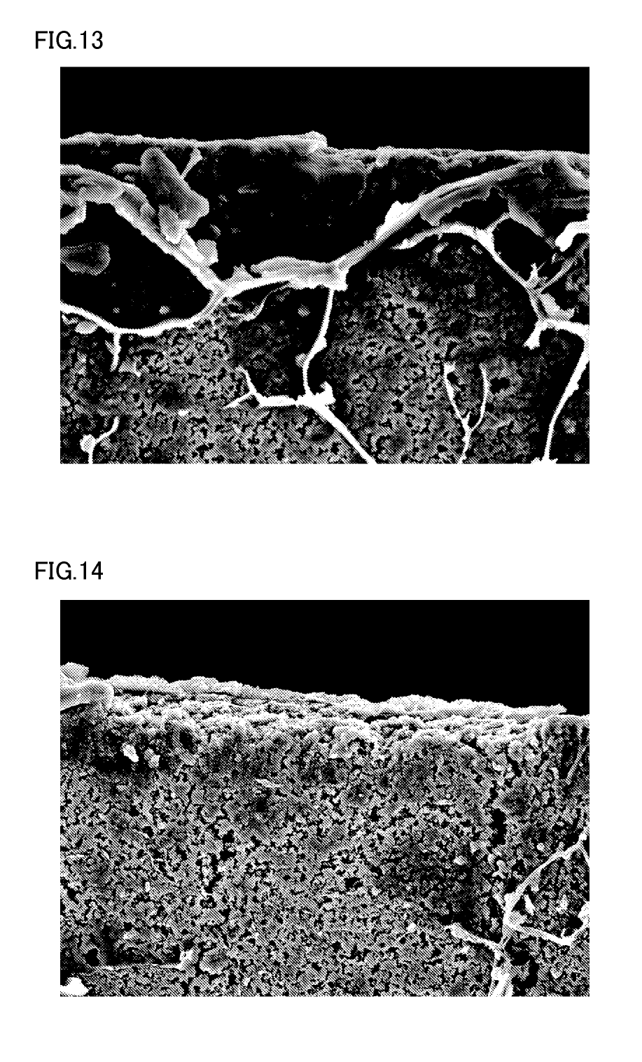

Referring to FIGS. 13 and 14, porously observed portions are the surfaces the anode bodies provided with dielectric coats, and portions observed in the form of smooth layers and in the form of white hyphae are first conductive polymer layers. Comparing FIGS. 13 and 14 with each other, it has been observed that the first conductive polymer layer formed according to Example 1 was present in a larger quantity (more thickly) on an end portion (upper side in the photograph of FIG. 10) of the anode body to sufficiently cover an end surface of the anode body. On the other hand, it has been recognized that the first conductive polymer layer formed according to comparative example 1 was not capable of sufficiently covering an end surface of the anode body although the same was present on an end portion of the anode body positioned on the right side in FIG. 11, for example.

Comparing Examples 1 to 5 with each other, it was possible to manufacture electrolytic capacitors having superior electric characteristics by employing ethanol rather than water. In other words, it has been recognized that alcohol having a low boiling point is suitably employed as the solvent for the first liquid composition.

From Examples 1 to 4, it has been recognized that the heating temperature in the step of forming the first conductive polymer layer may be at least 20° C., preferably at least 50° C., and more preferably at least 70° C. from the boiling point of the solvent.

It has been recognized from Example 9 that an electrolytic capacitor having excellent electric characteristics can be manufactured also by filling the space between anode body 21 and cathode body 22 with the electrolyte in place of providing a second conductive polymer layer.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An electrolytic capacitor comprising a wound element formed by winding an anode body consisting of a band-shaped metal foil and a dielectric coat provided on the surface of said metal foil and a cathode body consisting of a band-shaped metal foil in the longitudinal direction,
comprising a first conductive polymer layer provided on the surface of said anode body, wherein
said first conductive polymer layer is provided to be more thickly present on an end portion of said anode body in the width direction than on a central portion of said anode body in the width direction on the surface of said anode body.

2. The electrolytic capacitor according to claim 1, wherein
said first conductive polymer layer is a layer containing a conductive solid prepared from a liquid composition consisting of at least either a dispersion containing particles of said conductive solid or a solution in which said conductive solid is dissolved.

3. The electrolytic capacitor according to claim 1, wherein
a second conductive polymer layer is provided on said first conductive polymer layer.

4. The electrolytic capacitor according to claim 2, wherein
a second conductive polymer layer is provided on said first conductive polymer layer.

5. The electrolytic capacitor according to claim 1, wherein
a space between said anode body provided with said first conductive polymer layer and said cathode body is filled with an electrolyte.

6. The electrolytic capacitor according to claim 2, wherein
a space between said anode body provided with said first conductive polymer layer and said cathode body is filled with an electrolyte.

7. A method of manufacturing an electrolytic capacitor including a wound element formed by winding an anode body consisting of a band-shaped metal foil and a dielectric coat provided on the surface of said metal foil and a cathode body consisting of a band-shaped metal foil in the longitudinal direction, comprising the step of:
forming a first conductive polymer layer to be more thickly present on an end portion of said anode body in the width direction than on a central portion of said anode body in the width direction on the surface of said anode body, wherein
said first conductive polymer layer containing a conductive solid is prepared from a liquid composition consisting of at least either a dispersion containing particles of said conductive solid or a solution in which said conductive solid is dissolved in the step of forming said first conductive polymer layer.

8. The method of manufacturing an electrolytic capacitor according to claim 7, further comprising a step of forming a second conductive polymer layer on said first conductive polymer layer after the step of forming said first conductive polymer layer.

9. The method of manufacturing an electrolytic capacitor according to claim 7, filling a space between said anode body provided with said first conductive polymer layer and said cathode body with an electrolyte after the step of forming said first conductive polymer layer.

10. A method of manufacturing an electrolytic capacitor including a wound element formed by winding an anode body consisting of a band-shaped metal foil and a dielectric coat provided on the surface of said metal foil and a cathode body consisting of a band-shaped metal foil in the longitudinal direction, comprising the steps of:
impregnating said wound element with a liquid composition consisting of at least either a dispersion containing particles of a conductive solid or a solution in which said conductive solid is dissolved; and
forming a first conductive polymer layer containing said conductive solid by heating said wound element impregnated with said liquid composition in a reduced pressure environment of not more than atmospheric pressure at a temperature of at least the boiling point of a solvent for said liquid composition.

11. The method of manufacturing an electrolytic capacitor according to claim 10, further comprising a step of forming a second conductive polymer layer on said first conductive polymer layer after the step of forming said first conductive polymer layer.

12. The method of manufacturing an electrolytic capacitor according to claim 10, filling a space between said anode body provided with said first conductive polymer layer and said cathode body with an electrolyte after the step of forming said first conductive polymer layer.

13. A method of manufacturing an electrolytic capacitor including a wound element formed by winding an anode body consisting of a band-shaped metal foil and a dielectric coat provided on the surface of said metal foil and a cathode body consisting of a band-shaped metal foil in the longitudinal direction, comprising the steps of:
applying a liquid composition consisting of at least either a dispersion containing particles of a conductive solid or a solution in which said conductive solid is dissolved to end portions of said anode body positioned on the sides of the upper surface and the bottom surface of said wound element respectively; and
forming a first conductive polymer layer containing said conductive solid by heating said wound element coated with said liquid composition.

14. The method of manufacturing an electrolytic capacitor according to claim 13, further comprising a step of forming a second conductive polymer layer on said first conductive polymer layer after the step of forming said first conductive polymer layer.

15. The method of manufacturing an electrolytic capacitor according to claim 13, filling a space between said anode body provided with said first conductive polymer layer and said cathode body with an electrolyte after the step of forming said first conductive polymer layer.

16. A method of manufacturing an electrolytic capacitor including a wound element formed by winding an anode body consisting of a band-shaped metal foil and a dielectric coat provided on the surface of said metal foil and a cathode body consisting of a band-shaped metal foil in the longitudinal direction, comprising the steps of:
applying a liquid composition consisting of at least either a dispersion containing particles of a conductive solid or a solution in which said conductive solid is dissolved to the surface of said anode body to be more thickly present on an end portion of said anode body in the width direction than on a central portion of said anode body in the width direction on the surface of said anode body;
forming a first conductive polymer layer containing said conductive solid by heating said anode body coated with said liquid composition; and
forming said wound element by winding said anode body provided with said first conductive polymer layer in the longitudinal direction.

17. The method of manufacturing an electrolytic capacitor according to claim 16, further comprising a step of forming a second conductive polymer layer on said first conductive polymer layer after the step of forming said first conductive polymer layer.

18. The method of manufacturing an electrolytic capacitor according to claim 16, filling a space between said anode body provided with said first conductive polymer layer and said cathode body with an electrolyte after the step of forming said first conductive polymer layer.
